(19) United States
(12) Patent Application Publication
(10) Pub. No.: US 2015/0104548 A1
(43) Pub. Date: Apr. 16, 2015

(54) MILK STEAMER

(71) Applicant: G. E. W. International Corporation Limited, Hong Kong (CN)

(72) Inventor: Thomas Chung Lik Yip, Hong Kong (CN)

(21) Appl. No.: 14/503,553

(22) Filed: Oct. 1, 2014

(30) Foreign Application Priority Data
Oct. 12, 2013 (CN) 201310477579.6

(51) Int. Cl. A47J 31/44

(52) U.S. Cl. CPC A47J 31/4489
USPC 426/231; 137/334

(57) ABSTRACT

In a milk steamer, a changeover valve and a vent valve are connected to the inlet and the outlet of a steam-generating thermoblock to provide ready draining of water, and to mitigate condensation of steam that draws milk into the steam nozzle. In an automatic milk steamer, the height of the steam nozzle above the milk level is automatically set by interaction between a drive mechanism and a liquid level sensor.

### TECHNICAL FIELD

The present invention relates to milk steamers and methods for operating such milk steamers.

### BACKGROUND OF THE INVENTION

The invention generally relates to a milk steamer in which water is heated in a so-called thermoblock in order to produce steam. The term “thermoblock” as used herein refers to a heat exchanger in which water is heated (e.g. by resistance elements) while it is pumped. In contrast, in a boiler the steam is dispensed only after the heating is finished. Generally boilers have a much higher thermal inertia with a resulting slower response to heat inputs. On the other hand, thermoblocks provide high heating rates and consequently consume considerable electric power while in operation.

A milk steamer according to the present invention is provided with a steam outlet, as in the form of a nozzle, for steaming milk. The milk steamer may be a stand-alone device, or part of a larger machine, such as a coffee machine.

EP1764014 describes milk steamer that employs a thermoblock for generating steam that is dispensed from a steam nozzle, such as may be used for steaming milk. The thermoblock may be evacuated by way of a two-way vent valve connecting an inlet side of the thermoblock to an evacuation outlet, while a two-way shut-off valve connects the outlet side of the thermoblock to the steam nozzle. This arrangement protects the pump from high temperature and back pressure and provides for the thermoblock to be readily emptied to reduce scale deposition. However under certain operating conditions, condensation of steam in the nozzle produces a vacuum that draws milk into the nozzle. Also, due to the quantity of steam that may be evacuated through the vent valve, this vented flow passes through a condenser, before being exhausted into the evacuation outlet. Moreover, complex control and timing of valve actuations is needed.

Automatic steaming devices are known which allow anyone to obtain frothy milk without any skill, however many of these prior art devices have various drawbacks including unsatisfactory or inconsistent flavour and foam texture, lack of versatility, and high complexity and manufacturing costs. It will be understood that there is an unmet need for improved automatic steaming devices which address these drawbacks.

It is an object of the present invention to overcome or substantially ameliorate the above disadvantages or more generally to provide an improved milk steamer.

### DISCLOSURE OF THE INVENTION

According to one aspect of the present invention there is provided a milk steamer comprising:
a water reservoir;
a supply line connected to the water reservoir;
a pump connected in the supply line for generating a water flow;
a thermoblock for generating steam;
a changeover valve for selectively connecting an inlet of the thermoblock to the supply line;
a steam outlet, the steam outlet being supplied during use with steam from an outlet of the thermoblock; and
a vent valve for alternately connecting the steam nozzle to either the outlet of the thermoblock or an evacuation outlet.

Preferably the milk steamer further comprises a return line connected between the water reservoir and the changeover valve, wherein the changeover valve alternately connects the inlet of the thermoblock to either the supply line or the return line.

Preferably both the changeover valve and vent valve are three-way two-position valves that are solenoid actuated, and spring biased to respective normal positions, wherein in the normal position of the changeover valve the inlet of the thermoblock is connected to the return line, and in the normal position of the vent valve the steam outlet is connected to the evacuation outlet.

Preferably the evacuation outlet is located at a lower position than the inlet side of the thermoblock.

Preferably the changeover valve and vent valve of both moved to and from their normal position substantially simultaneously. By having the changeover valve and vent valve both moved to and from their normal position substantially simultaneously the control of the machine is simplified compared to prior art where delays must be implemented between valve operations.

In another aspect the invention comprises an automatic milk steamer for use with a vessel positioned on a support, comprising:
a steam generator;
a steam nozzle in communication with the steam generator;
a drive mechanism for raising and lowering one of the steam nozzle and the support with respect to the other of the other of the steam nozzle and the support;
a sensing probe connected to the nozzle including a level sensor for sensing a liquid level and providing a liquid level signal, and a temperature sensor for sensing a liquid temperature and providing a liquid temperature signal, and
a controller for controlling the drive mechanism in response to the liquid level signal so as to position the nozzle at a height relative to a liquid level in the vessel.

Preferably the sensing probe includes to the controller.

Preferably the drive mechanism raises and lowers the one of the steam nozzle and the support on a linear path.

Preferably the support is mounted to a housing of the automatic milk steamer,

Preferably the level sensor is a resistive level sensor, and a tip of the sensing probe protrudes below a tip of the steam nozzle. Alternatively, the level sensor may be a float type sensor, a magnetic, capacitance, optical, or other type of level sensor.

Preferably the drive mechanism includes motor-driven screw for raising and lowering one of the steam nozzle and the support. Alternatively, the drive mechanism may comprise a linear actuator, a rope and pulley system, or any of the many well known raising and lowering mechanisms.

In yet another aspect the invention comprises a milk steamer, comprising:
a steam generator;
a steam nozzle in communication with the steam generator;
a sensing probe connected to the steam nozzle including a level sensor for sensing a liquid level and providing a liquid level signal, and a temperature sensor for sensing a liquid temperature and providing a liquid temperature signal;
a controller for receiving the liquid level signal, and
an indicator operatively coupled to the controller and responsive to the liquid level signal for providing an indication to the user of that the nozzle is disposed at a predetermined position relative to a liquid level in the vessel.

The indicator may comprise an audible, visual, or other indicator. For instance, the indicator may comprises a sound generator, or light generator, which is switched on or off by the controller when the nozzle is disposed at the predetermined position relative to the liquid level. Alternatively the indicator may comprises a vibrator for vibrating the steam nozzle, which is vibrator switched on or off by the controller when the nozzle is disposed at the predetermined position relative to the liquid level. In another aspect the invention provides a method of operating the above-described automatic milk steamer comprising:
a) actuating the drive mechanism to raise or lower the one of the steam nozzle and the support;
b) monitoring the liquid level signal and, when a first liquid level is detected, stopping the drive mechanism and activating the steam generator to dispense steam from the steam nozzle.

Preferably the method further comprises the step of:
d) monitoring the temperature signal and, when a first temperature level is detected, stopping the steam generator.

Preferably the method further comprises the step of:
e) actuating the drive mechanism to raise or lower the one of the steam nozzle and the support.

This invention provides an automatic milk steamer which is effective and efficient in operational use, and which produces consistent flavour and foam texture. The device may be economically constructed and has an simple overall design that minimizes manufacturing costs and maximizes performance.

### BRIEF DESCRIPTION OF THE DRAWINGS

Preferred forms of the present invention will now be described by way of example with reference to the accompanying drawings, wherein:

FIG. 1 is a schematic of a milk steamer according to the invention, and

FIGS. 2 and 3 are schematic illustrations of first and second embodiments respectively of an automatic milk steamer.

### DESCRIPTION OF THE PREFERRED EMBODIMENTS

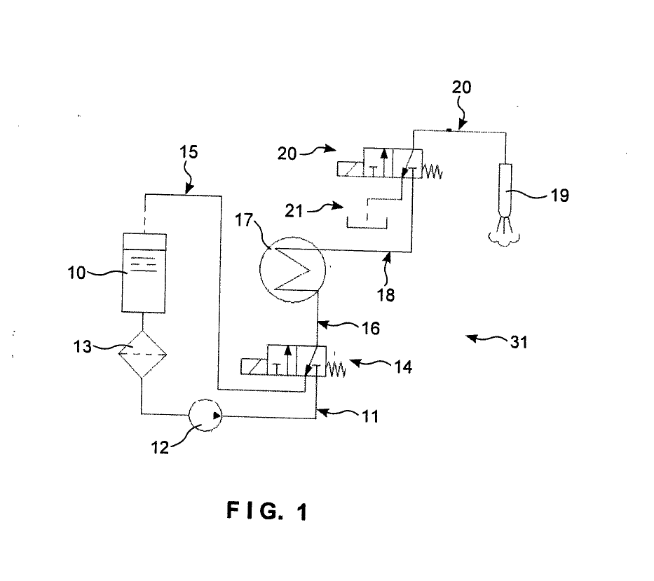

Referring to FIG. 1, a milk steamer generally comprises steam generator 31 connected to a steam nozzle 19 which, in use, is inserted into a vessel containing the milk to be steamed and foamed. The steam generator 31 includes a water reservoir 10 with a supply line 11 connected to the water reservoir 10 and a pump 12 connected in the supply line 11 for generating a water flow. A filter 13 may be connected in the supply line between the water reservoir 10 and the pump 12. A return line 15 may carry a return flow to the water reservoir 10. A steam-generating thermoblock 17 is supplied with water via a changeover valve 14 that selectively connects an inlet 16 of the thermoblock to the supply line 11. The changeover valve 14 may alternately connect the inlet 16 of the thermoblock to either the supply line 11 or the return line 15. An outlet 18 of the thermoblock is connected via a vent valve 20 to the steam nozzle 19. Also connected to the vent valve 20 is an evacuation outlet 21, which may be in the form of an open tray. The vent valve 20 alternately connects the steam nozzle 19 to either the outlet 18 of the thermoblock or the evacuation outlet 21.

FIG. 1 illustrates the vent valve 20 and changeover valve 14 in their first positions or normal states, as when no power is supplied to operate the machine. The vent valve 20 and changeover valve 14 may be three-way two-position valves, such as a solenoid-operated valves spring biased to the positions shown in FIG. 1. In this state, the vent valve 20 is positioned such that the steam nozzle 19 is connected to the evacuation outlet 21 and, by evacuating the steam nozzle 19 in this way, the possibility of condensing steam drawing milk into the nozzle 19 is mitigated or avoided. Likewise, with the changeover valve 14 in its normal state as illustrated, the inlet 16 of the thermoblock is connected to the return line 15 so any water in the thermoblock 17 may drain out through the return line 15 to the reservoir 10.

In use, a controller (not shown) may control, in addition to other components, the actuation of the vent valve 20 and changeover valve 14, as well as the actuation of the pump 12, and the heating elements (not shown) of the thermoblock 17. Firstly, the thermoblock 17 is heated to its operating temperature, with the vent valve 20 and changeover valve 14 in their normal or first positions shown in FIG. 1. Some steam may be generated in the thermoblock 17 due to residual amounts of water, and this is vented by the changeover valve 14. To generate and dispense steam from the steam nozzle 19, both the vent valve 20 and changeover valve 14 may be simultaneously moved to their second positions (not shown), and the pump 12 is actuated to force water from the supply line 11 into the inlet 16 of the thermoblock 17 at a rate sufficient that steam is expelled through the vent valve 20 and out from the steam nozzle 19. The pump 12 may be a metering pump, such as a positive displacement pump, driven in a controlled manner, as by a stepper motor, for instance, in order to produce a defined amount of steam. Alternatively, flow metering can be used to control the pump.

To stop the generation and dispensing of steam, the changeover valve 14 and vent valve 20 may be simultaneously actuated and moved to their normal or first positions, as shown in FIG. 1, at the time the pump 12 is stopped. The water flow to the inlet 16 of the thermoblock is stopped, while the changeover valve 14 connects the inlet 16 of the thermoblock to the return line 15. The flow of steam from the outlet 18 of the thermoblock into the vent valve 20 is stopped, and vent valve 20 connects the steam nozzle 19 to the evacuation outlet 21. In this state steam pressure in the hot thermoblock 17 serves to evacuate the water from the inlet 16, directing it through the return line 15 to the reservoir 10. Steam in the steam nozzle 19 is vented through the vent valve 20 to the evacuation outlet 21. Once evacuated in this way, a sudden cooling of the nozzle 19 will not produce a vacuum that draws milk into the nozzle. As the amount of the steam in the steam nozzle 19 and connecting line 22 is small, there is no need for a condenser in this connecting line 22 between the vent valve 20 and evacuation outlet 21.

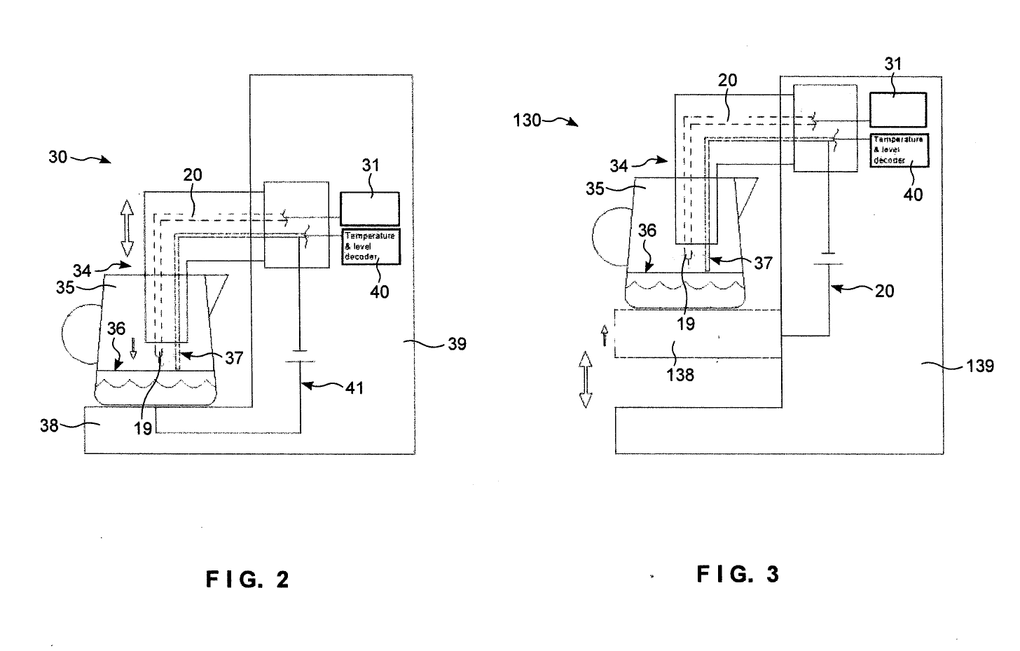

Two embodiments of an automatic milk steamer are shown FIGS. 2 and 3, in which either the nozzle assembly 34 is raised and lowered (FIG. 2) or the support 138 for supporting the vessel 35 is raised and lowered (FIG. 3) in order to position the steam nozzle 19 at a suitable height relative to the milk level 36. When so positioned, the jet of steam introduced into the milk both heats the milk, slightly caramelising it, and at the same time mixes in air which generates the foam. By accurately controlling the nozzle height relative to the milk level 36, and monitoring the milk temperature, steamed milk with good flavour and foam texture can reliably be produced.

The general construction of the nozzle assembly 34 is common in both embodiments, and may have a generally L-shaped form, protruding outwardly and downwardly from a housing section 39, 139 of the milk steamer. The nozzle assembly 34 includes the steam nozzle 19 and sensing probe 37, and may serve to connect these elements. The nozzle assembly 34 may include a body 43 that encloses the connecting line 22 joining the nozzle 19 to the steam generator 31, and the conductor 42 joining the sensing probe 37 to the controller 40.

In the embodiment of FIG. 2 the nozzle assembly 34 may be mounted to move in vertical guides (not shown), while the support 38 may be fixed to the housing section 39. In the embodiment of FIG. 3 the support 138 may be mounted to move in vertical guides (not shown), while the nozzle assembly 34 may be fixed to the housing section 39.

A drive mechanism 50 for raising and lowering the steam nozzle 19 or the support 138 may include an upright screw (not shown) rotated by a motor (not shown) via a transmission, and a nut (not shown) engaged with the screw and connected to either the nozzle assembly 34 (FIG. 2) or to the support 138 (FIG. 3).

The sensing probe 37 connected to the nozzle 19 includes a level sensor for sensing a liquid level and providing a liquid level signal, and a temperature sensor for sensing a liquid temperature and providing a liquid temperature signal. The sensing probe 37 is connected to the controller 40 in a circuit 41. The level sensor may be a resistive level sensor and the temperature sensor a thermocouple. A tip of the sensing probe may protrude below a tip of the steam nozzle 19 such that, in use, the tip of the steam nozzle 19 is disposed above the milk level 36.

The controller 40 controls the drive mechanism 50 and a steam generator 31, which may be of the type described above with reference to FIG. 1. In use, a vessel 35 holding milk is placed upon the support 38, 138 below the nozzle assembly 34. A single start button (not shown) may be actuated by the user, whereupon the controller 40 actuates the drive mechanism 50 to raise or lower the steam nozzle 34 (FIG. 2) or the support 138 (FIG. 3) while monitoring the liquid level signal from the sensing probe 37. When a first liquid level is detected, the controller 40 stops the drive mechanism 50 and activates the steam generator 31 to dispense steam from the steam nozzle 19. While the steam is ejected, the controller 40 monitors the temperature signal from the sensing probe 37 and, when a first temperature level is detected, stops the steam generator 31. The controller 40 may subsequently actuate the drive mechanism 50 to raise or lower the steam nozzle 34 or the support 138 which, optionally together with another indicator such as a sound or display, indicates the completion of the operation.

In a further alternative embodiment (not shown) the nozzle assembly 34 may be fixed to the housing section 139 as in the embodiment of FIG. 3 and the moving support 138 is an optional feature. In this alternative embodiment an indicator is operatively coupled to the controller and is responsive to the liquid level signal for providing an indication to the user of that the nozzle is disposed at a predetermined position relative to a liquid level in the vessel. In this way the user can employ the conventional manual technique, whereby the jug of milk is manually held beneath the steam nozzle 19, but the indicator assists unskilled users, by alerting the user when the nozzle is disposed at the proper height relative to the milk level. The indication may take the form of an audible, visual, or vibratory alert that starts or stops when the steam nozzle 19 is properly positioned relative to the liquid level.

Aspects of the present invention have been described by way of example only and it should be appreciated that modifications and additions may be made thereto without departing from the scope thereof.

1. A milk steamer comprising:
a water reservoir;
a supply line connected to the water reservoir;
a pump connected in the supply line for generating a water flow;
a thermoblock for generating steam;
a changeover valve for selectively connecting an inlet of the thermoblock to the supply line;
a steam outlet, the steam outlet being supplied, during use of the milk steamer, with steam from an outlet of the thermoblock; and
a vent valve for alternately connecting a steam nozzle to either the outlet of the thermoblock or an evacuation outlet.

2. The milk steamer according to claim 1 further comprising a return line connected between the water reservoir and the changeover valve, wherein the changeover valve alternately connects the inlet of the thermoblock to either the supply line or the return line.

3. The milk steamer according to claim 2 wherein
both the changeover valve and the vent valve are three-way, two-position valves that are solenoid actuated, and spring biased to respective normal positions,
in the normal position of the changeover valve, the inlet of the thermoblock is connected to the return line, and
in the normal position of the vent valve, the steam outlet is connected to the evacuation outlet.

4. The milk steamer according to claim 1 wherein the evacuation outlet is located at a lower position than the inlet side of the thermoblock.

5. A method for operating a milk steamer according to claim 3, including moving the changeover valve and the vent valve to and from their respective normal positions substantially simultaneously.

6. An automatic milk steamer for use with a vessel positioned on a support, comprising:
a steam generator;
a steam nozzle in communication with the steam generator;
a drive mechanism for raising and lowering one of the steam nozzle and the support with respect to the other of the steam nozzle and the support;
a sensing probe connected to the nozzle and including
a level sensor for sensing level of a liquid in the vessel and providing a liquid level signal, and
a temperature sensor for sensing temperature of the liquid in the vessel and providing a liquid temperature signal; and
a controller for controlling the drive mechanism in response to the liquid level signal to position the steam nozzle at a height relative to the level of the liquid in the vessel.

7. The automatic milk steamer of claim 6 wherein the drive mechanism raises and lowers the one of the steam nozzle and the support on a linear path.

8. The automatic milk steamer of claim 6 wherein the support is mounted to a housing of the automatic milk steamer.

9. The automatic milk steamer of claim 6 wherein the level sensor is a resistive level sensor, and the sensing probe includes a tip protruding below a tip of the steam nozzle.

10. The automatic milk steamer of claim 6 wherein the drive mechanism includes a motor-driven screw for raising and lowering one of the steam nozzle and the support.

11. A milk steamer, comprising:
a steam generator;
a steam nozzle in communication with the steam generator;
a sensing probe connected to the steam nozzle and including
a level sensor for sensing level of a liquid and providing a liquid level signal, and
a temperature sensor for sensing temperature of the liquid and providing a liquid temperature signal;
a controller for receiving the liquid level signal; and
an indicator operatively coupled to the controller and responsive to the liquid level signal for providing an indication to a user of the milk steamer that the steam nozzle is disposed at a predetermined position relative to the level of the liquid.

12. The milk steamer of claim 11 wherein the indicator comprises an audible or visual indicator.

13. The milk steamer of claim 12 wherein the indicator is switched on or off by the controller when the steam nozzle is disposed at the predetermined position relative to the level of the liquid.

14. The milk steamer of claim 11 wherein
the indicator comprises a vibrator for vibrating the steam nozzle, and
the vibrator is switched on or off by the controller when the nozzle is disposed at the predetermined position relative to the level of the liquid.

15. The milk steamer of claim 11 wherein
the level sensor is a resistive level sensor, and
the sensing probe includes a tip protruding below a tip of the steam nozzle.

16. A method of operating the automatic milk steamer of claim 6 comprising:
a) actuating the drive mechanism to raise or lower the one of the steam nozzle and the support; and
b) monitoring the liquid level signal and, when a first liquid level is detected, stopping the drive mechanism and activating the steam generator to dispense steam from the steam nozzle.

17. The method of claim 16 further comprising:
c) monitoring the liquid temperature signal and, when a first temperature level is detected, stopping the steam generator.

18. The method of claim 17 further comprising:
d) actuating the drive mechanism to raise or lower the one of the steam nozzle and the support.
